(19) United States
(12) Patent Application Publication
(10) Pub. No.: US 2013/0166051 A1
(43) Pub. Date: Jun. 27, 2013

(54) HVAC UNIT WITH AUDIO MONITORING, A METHOD OF AUDIO MONITORING EVENTS OF AN HVAC UNIT AND A CONTROLLER CONFIGURED TO PERFORM THE METHOD OF AUDIO MONITORING

(71) Applicant: Erroll Eaton, McKinney, TX (US)

(72) Inventor: Erroll Eaton, McKinney, TX (US)

(73) Assignee: Lennox Industries, Inc., Richardson, TX (US)

(21) Appl. No.: 13/333,821

(22) Filed: Dec. 21, 2011

(51) Int. Cl. G05D 23/19

(52) U.S. Cl. 700/94

(57) ABSTRACT

Disclosed herein are a heating, ventilating, and air conditioning (HVAC) unit and a HVAC controller. Additionally, a computer program product is disclosed. In one embodiment, the HVAC controller includes: (1) an interface configured to receive audio data from a listening system of the HVAC unit and (2) a mechanical behavior evaluator coupled to the interface and configured to verify occurrence of an event of the HVAC unit based on the audio data.

### TECHNICAL FIELD

This application is directed, in general, to heating, ventilating and air conditioning (HVAC) systems and, more specifically, to monitoring the operation of HVAC systems.

### BACKGROUND

HVAC systems can be used to regulate the environment within an enclosed space. Typically, an air blower is used to pull air from the enclosed space into the HVAC system through ducts and push the air back into the enclosed space through additional ducts after conditioning the air (e.g., heating, cooling or dehumidifying the air). Various types of HVAC systems, such as roof top units, may be used to provide conditioned air for enclosed spaces.

Many HVAC systems have been improved with various options to provide higher efficiency and better comfort. Accordingly, HVAC systems have typically become more complex resulting in a cost increase for installation and service.

To minimize failures in the HVAC systems, manufacturers typically design their HVAC systems for reliability and robustness. Additionally, vendors and suppliers design their parts to last a specified period of time. Unfortunately, the resulting parts can vary based on the age of machines and materials used for fabrication. Assembling the various fabricated parts during manufacturing can also cause different maintenance scenarios. As such, fabricating and assembling components of an HVAC system can result in unwanted behavior of the various components.

### SUMMARY

In one aspect, an HVAC controller is disclosed. In one embodiment, the controller includes: (1) an interface configured to receive audio data from a listening system of the HVAC unit and (2) a mechanical behavior evaluator coupled to the interface and configured to verify occurrence of an event of the HVAC unit based on the audio data.

In another aspect, a computer program product, comprising a non-transitory computer usable medium having a computer readable program code embodied therein, wherein the computer readable program code is adapted to be executed to implement a method of audio monitoring of events of HVAC unit. In one embodiment, the method includes: (1) receiving audio data from a listening system of the HVAC unit, the audio data associated with an event of the HVAC unit, (2) comparing the audio data to at least one audio recording that corresponds to the event and (3) verifying occurrence of the event based on the comparing.

In yet another aspect, a HVAC unit is provided. In one embodiment, the HVAC unit includes: (1) a heating or cooling system configured to provide conditioned air, the heating or cooling system having a component, (2) a listening system configured to detect sound corresponding to an event associated with the component and generate audio data of the sound and (3) a controller coupled to the operating system and the listening system. The controller includes (3A) an interface configured to receive the audio data from the listening system of the HVAC unit and (3B) a mechanical behavior evaluator coupled to the interface and having a sound reservoir configured to store audio recordings of various events associated with the operating system and a sound examiner configured to verify occurrence of the event based on the audio data.

### BRIEF DESCRIPTION

Reference is now made to the following descriptions taken in conjunction with the accompanying drawings, in which:

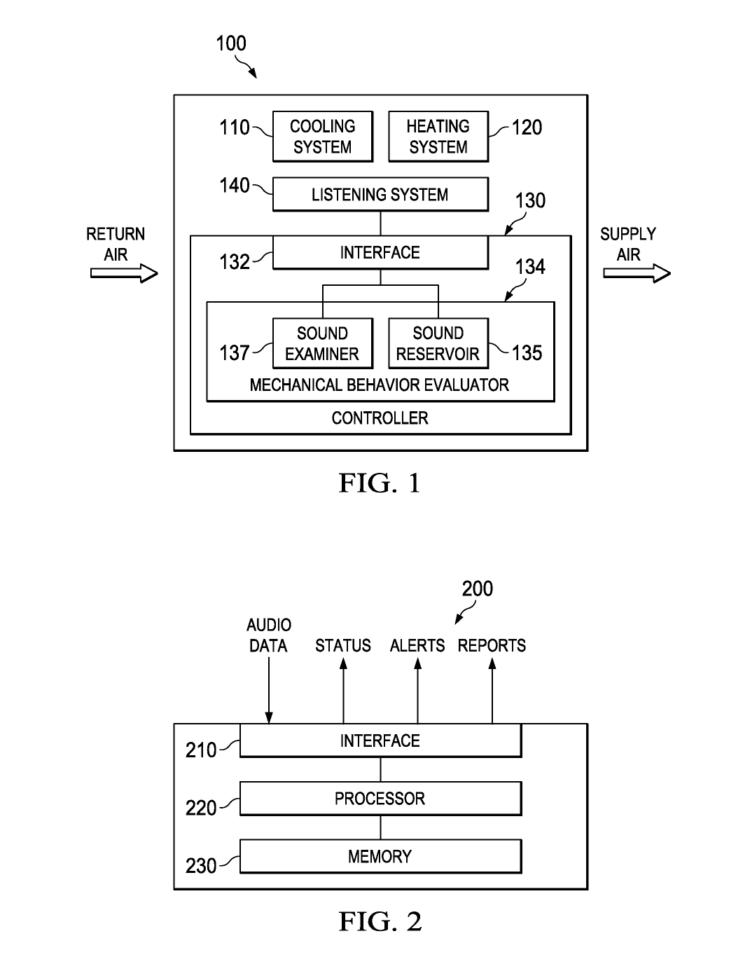

FIG. 1 illustrates a block diagram of an embodiment of an HVAC system constructed according to the principles of the disclosure;

FIG. 2 illustrates a block diagram of an embodiment of a controller constructed according to the principles of the disclosure;

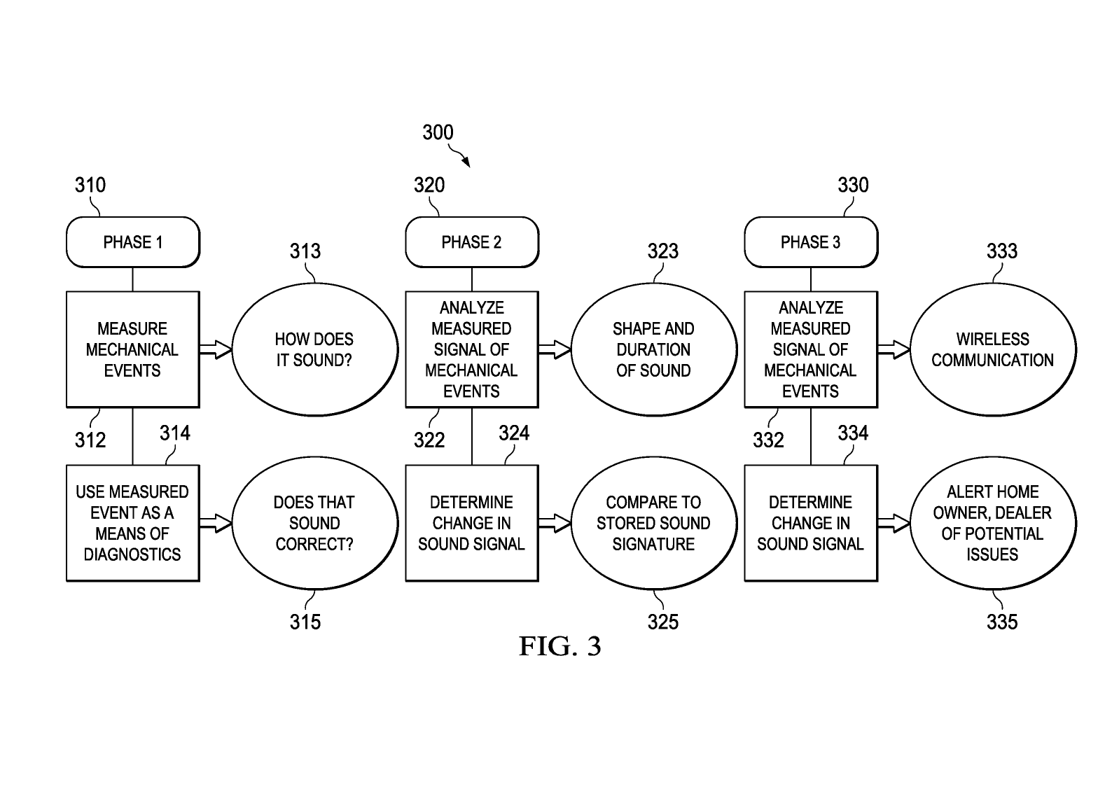

FIG. 3 illustrates a chart representing various operating phases of a sound examiner of, for example, the mechanical behavior evaluator of FIG. 1;

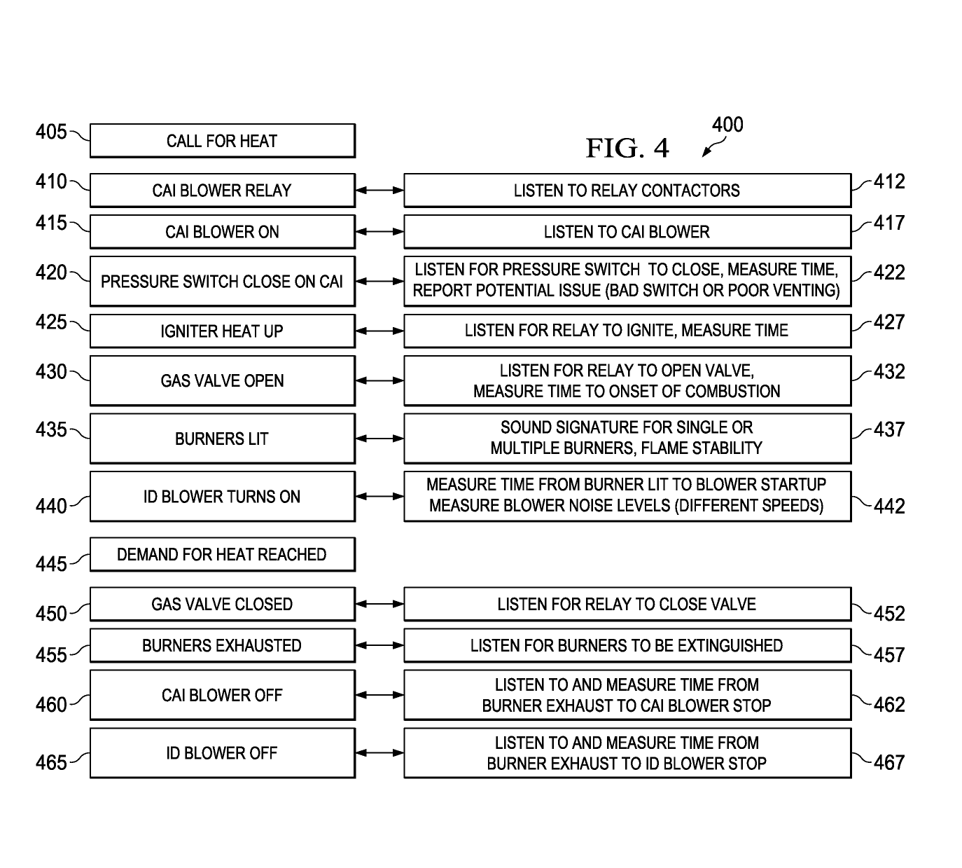

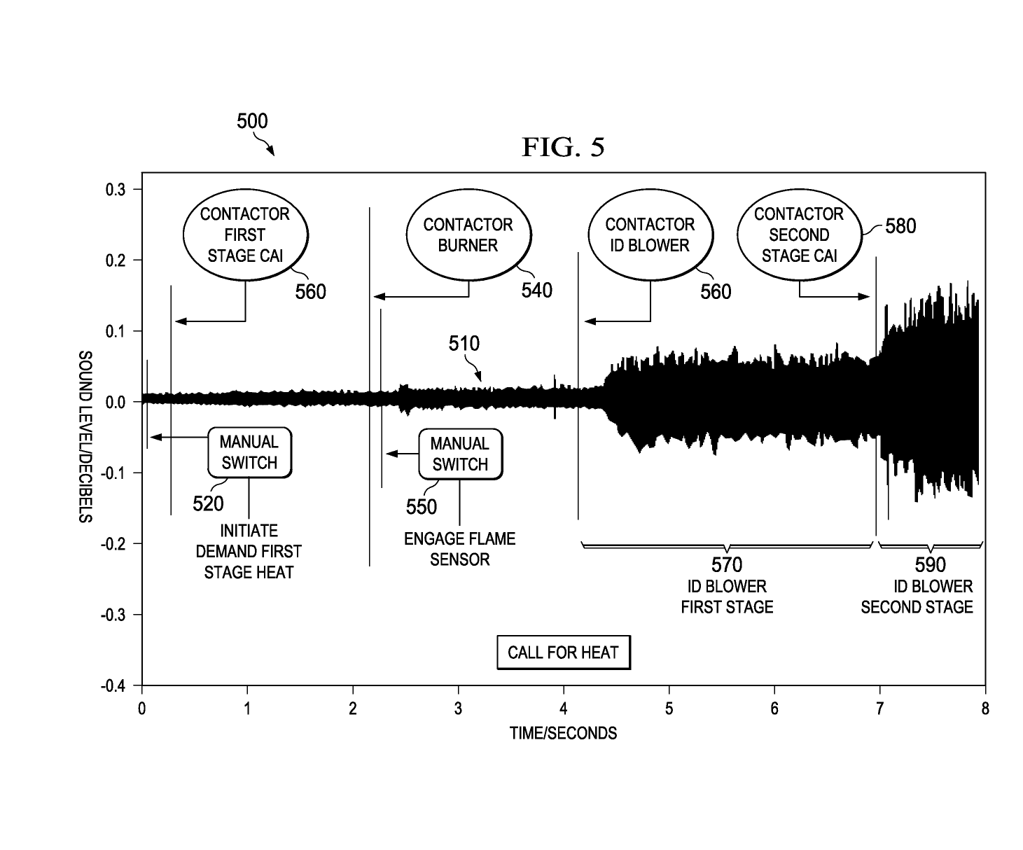

FIG. 4 illustrates a detailed flow diagram of an embodiment of a method of carrying out audio monitoring of an HVAC unit;

FIG. 5 illustrates a diagram representing an embodiment of audio measurement and analysis of an HVAC system when a call for heat occurs according to the principles of the disclosure;

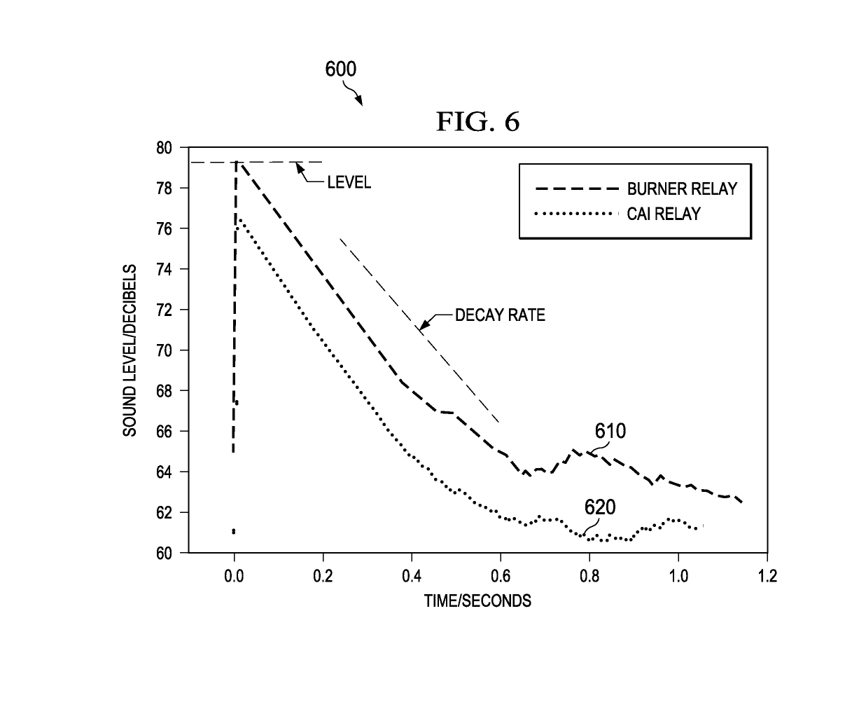

FIG. 6 illustrates a diagram representing a sound signature as employed in an embodiment of a mechanical behavior evaluator constructed according to the principles of the disclosure; and

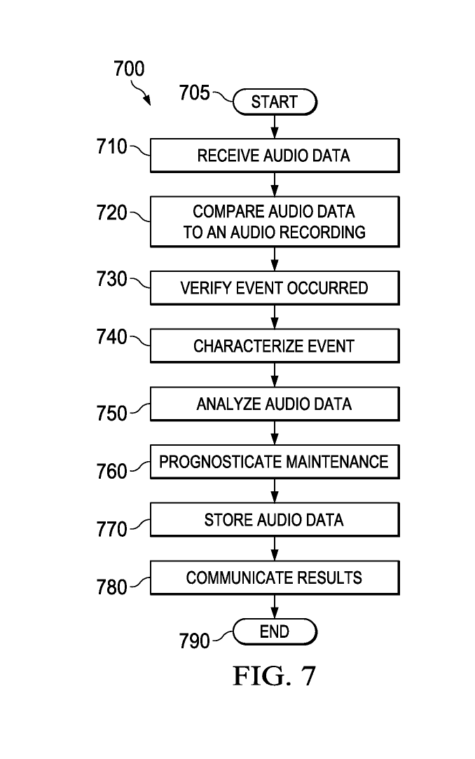

FIG. 7 is a flow diagram of an embodiment of a method of audio monitoring of events carried out according to the principles of the disclosure.

### DETAILED DESCRIPTION

Even with reliable and robust component designs, the fabrication and manufacturing variations of HVAC components can cause early failures or unwanted behavior. Though scheduled maintenance is often recommended for HVAC systems, this can miss faulty components that were not fabricated or assembled properly. Without detecting the possible variations of components, early component failures can result that reduce customer satisfaction and can cause additional damage to other components.

The disclosure provides measurement and analysis of sound, including from vibration, produced by mechanical events occurring during the initiation, operation and shutdown of HVAC components. The detected sound can be employed to provide audio verification of events that occur during the initiation, operation and shutdown of an HVAC unit. The events include, for example, but not limited to the initiating, operating and/or shutting down of a fan, a contact, a burner or burners, a compressor or compressors and an economizer.

A mechanical behavior evaluator is disclosed that includes a sound reservoir and a sound examiner. The sound reservoir stores a library of audio recordings that represent HVAC unit events. The audio recordings are obtained before installation of the HVAC unit during, for example, manufacturing and testing of the HVAC units. The audio recordings are typically obtained in a lab using microphones that detect sound during the occurrence of known events. The audio recordings are then associated with the known events and stored. The audio recordings represent normal operation of components during the events and can be used as benchmarks for comparison. During operation of an installed HVAC unit, audio data obtained during events can be stored with the audio recordings to provide further data for comparison. The audio recordings may be sound signatures. FIG. 6 provides an example of a sound signature.

The sound examiner verifies occurrence of the various events based on the audio data obtained during the period of time for the events to occur. The sound examiner can receive a signal, such as from an HVAC controller, indicating intent of an event and determine if received audio data corresponds to the occurrence of the event. The sound examiner can employ a timer to determine the time difference between audio verification of the event and when the event should have occurred. The noted time can be used by the sound examiner for further examination of the event. The sound examiner can also characterize the occurrence of the event. Thus, instead of just indicating that the event occurred, the sound examiner can indicate if the event occurred properly. In other words, the sound examiner can determine if the audio data for the event sounds correct compared to a stored audio recording of the normal occurrence of the event.

Additionally, the sound examiner can prognosticate maintenance needs for a component or components associated with events by comparing the measured audio data to the proper corresponding audio recordings. As such, the disclosure provides an audio system and scheme for not only verifying the operation of an HVAC unit but also for preventing mechanical failure. Thus, instead of relying on scheduled maintenance, maintenance based on the actual condition of HVAC components can be obtained. This can provide just-in-time maintenance and also prevent unnecessary maintenance.

The disclosure provides systems and schemes to detect a desired event of an HVAC unit using sound characteristics of that event. Additionally, sound signatures are analyzed for faults, mechanical degradation of contactors and other components such as compressor slugging, fan noise, motor tones and bearing failure. Remote or wireless monitoring is also disclosed. Data storage of known acoustic signatures for comparison to a particular acoustic event is also disclosed herein.

FIG. 1 illustrates a block diagram of an embodiment of an HVAC unit 100 constructed according to the principles of the disclosure. The HVAC unit 100 receives air, conditions the air and supplies conditioned air. The HVAC unit 100 may be a residential unit or a commercial unit, such as a roof top unit or another type of packaged unit. The HVAC unit 100 may include a furnace, electrical heating, indoor systems, outdoor systems or a combination of both indoor and outdoor systems.

The HVAC unit 100 includes a cooling system 110, a heating system 120, a controller 130 and a listening system 140. One skilled in the art will understand that the HVAC unit 100 may include additional components and devices that are not presently illustrated or discussed but are typically included in an HVAC system, such as, a power supply, a cabinet and vents. A thermostat (not shown) is also typically employed with an HVAC system and used as a user interface. Additionally, one skilled in the art will understand that the principles of the disclosure also apply to HVAC units or systems that do not include both a heating and a cooling system.

The cooling system 110 is designed to provide cooled air to an enclosure (not shown) and the heating system 120 is designed to provide heated air to the enclosure (e.g., a building). Both the cooling system 110 and the heating system 120 may include conventional components that are typically employed in cooling and heating systems. For example, the cooling system 110 can include a cooling air blower and a cooling coil. Additionally, the heating system 120 can include a heating air blower and a heating element. In embodiments employing gas heat, the heating system 120 includes additional components, such as, a combustion air inducer (CAI). In some embodiments, a single air blower may be used for both the cooling and the heating system.

At least some of the operation of the HVAC unit 100 can be controlled by the controller 130. As such, the controller 130 can be configured as a typical HVAC controller to direct and monitor the operation of an HVAC unit. In addition to directing the operation of the cooling and heating systems 110, 120, the controller 130 is also configured to provide audio monitoring and management for the HVAC unit 100.

The controller 130 includes an interface 132 and a mechanical behavior evaluator 134. The mechanical behavior evaluator 134 may be implemented on a processor and/or a memory of the controller 130. The mechanical behavior evaluator 134 may be embodied as a series of operation instructions that direct the operation of a processor when initiated thereby. In one embodiment, the mechanical behavior evaluator 134 is implemented in at least a portion of a memory of an HVAC controller, such as a non-transistory computer readable medium of the HVAC controller. The mechanical behavior evaluator 134 can be embodied as a computer program product. The mechanical behavior evaluator 134 includes a sound reservoir 135 and a sound examiner 137.

The interface 132 may be a conventional interface that employs a known protocol for communicating (i.e., transmitting and/or receiving) data. The interface 132 may be configured to receive both analog and digital data. The data may be received over wired, wireless or both types of communication mediums. In some embodiments, a communications bus may be employed to communicate data between various components of the HVAC unit 100 and the controller 130. The interface 132 is configured to communicate feedback data and control signals to direct the operation of the HVAC unit 100.

The interface 132 is also configured to receive audio data from the listening system 140. The audio data is typically in the form of electrical signals provided by a microphone or microphones of the listening system 140. The interface 132 is also configured to transmit outputs generated by the sound examiner 137. In one embodiments, the various outputs of the sound examiner 137 include a verification status (e.g., yes or no), a characterization status (e.g., sounded incorrectly or correctly), an analysis report (e.g., identify an abnormal operating component) and a prognostication report (e.g., maintenance needed, needed within a designated time or needed within a designated number of events).

In contrast to conventional HVAC systems, the HVAC unit 100 also includes the listening system 140. The listening system 140 is configured to detect sounds corresponding to events of the HVAC unit 100 and generate audio data of the sounds. The sounds may correspond to particular components or a single component associated with the events. The listening system 140 may include one or multiple microphones positioned within the HVAC unit 100. The positioning of the listening system 140 with respect to the HVAC unit 100 may be restricted to a known location or locations. Thus, consistency of the audio data and audio recordings can be maintained and provide fair comparisons for benchmarking and determining degradation of components. A conventional microphone or microphones may be used for the listening system 140 to convert detected sound to the audio data. Conventional cabling, wiring or wireless communication may be used between the listening system 140 and the interface 132. In some embodiments, the listening system 140 includes at least two microphones. In one embodiment, one microphone is positioned proximate the CAI blower of the HVAC unit 100 and another microphone is positioned proximate the indoor air blower of the HVAC unit 100. As such, these microphones are positioned to detect sound from the CAI blower and the indoor air blower, respectively, without interfering with the operation thereof. In some embodiments, the listening system 140 includes multiple microphones that are strategically located throughout the HVAC unit and are used in combination to correlated gather sound and generate audio data for complex diagnostics and prognostics.

The sound reservoir 135 of the mechanical behavior evaluator 134 is configured to store audio recordings of various events associated with HVAC unit 100. In one embodiment, the audio recordings are predetermined sound signatures that correspond to particular events that occur during the initiating, operating and terminating of various components of the HVAC unit 100. The audio recordings are collected in for example, a sound lab, and then stored in the sound reservoir 135. In some embodiments, the audio recordings may be updated after installation from external audio data obtained from a lab or from another installed HVAC unit. As such, the audio monitoring of more components can be added after installation. Additionally, known audio recordings that have resulted in failure of a component can be added from similar HVAC units in the field. Updating or adding audio recordings to the sound reservoir can be performed via the interface 132 and by employing a user interface such as a keyboard, keypad or touch screen.

The sound examiner 137 is configured to process the received audio data and based thereon make determinations associated with various events and components of the HVAC unit 100. In one embodiment, the sound examiner 137 is configured to verify occurrence of an event based on audio data. In another embodiment, the sound examiner 137 is configured to characterize an occurrence by comparing the audio data to at least one of the audio recordings stored in the sound reservoir 135. Additionally, the sound examiner 137 can be configured to analyze the audio data by comparing the audio data to at least one of the audio recordings. In some embodiments, the sound examiner 137 is also configured to prognosticate needed maintenance for a component of the HVAC unit 100 based on comparing the audio data to at least one of the audio recordings. In some embodiments, the sound examiner 137 is configured to measure the time difference between audio verification and initiation of an event. This time difference can then be used for in further examination by the sound examiner 137. The time difference can be determined based on the difference between receive a signal indicating the initiation of an event and the audio verification of the event.

For characterizing, analyzing and prognosticating, the sound examiner 137 may be configured to examine multiple audio recordings of the sound reservoir 135. As such, a pattern of degradation can be determined for a component or components of the HVAC unit 100. In some embodiments, the sound examiner 137 may update the stored audio recordings with the audio data to provide even more audios to use for comparison and evaluation. The sound examiner 137 can also be configured to communicate the results of the various functions performed, including the condition and maintenance needs of components.

FIG. 2 illustrates a block diagram of an embodiment of a controller 200 constructed according to the principles of the disclosure. The controller 200 is configured to direct the operation of or at least part of the operation of an HVAC system, such as the HVAC unit 100. As such, the controller 200 is configured to generate control signals that are transmitted to the various components to direct the operation thereof. The controller 200 may generate the control signals in response to feedback data that is received from various sensors and/or components of the HVAC system. The feedback data includes audio data generated by a listening system of the HVAC system based on detected sound. The controller 200 includes an interface 210 that is configured to receive and transmit the feedback data and control signals. The interface 210 may be a conventional interface that is used to communicate (i.e., receive and transmit) data for a controller, such as a microcontroller.

The interface 210 may include a designated input terminal or input terminals that are configured to receive feedback data from a particular component. The controller 200 also includes a processor 220 and a memory 230. The memory 230 may be a conventional memory typically located within a controller, such as a microcontroller, that is constructed to store data and computer programs. The memory 230 may store operating instructions to direct the operation of the processor 220 when initiated thereby. The operating instructions may correspond to algorithms that provide the functionality of the operating schemes disclosed herein. For example, the operating instructions may correspond to the algorithm or algorithms that implement the method illustrated in FIG. 7. The processor 220 may be a conventional processor such as a microprocessor. The controller 200 also includes a display 240 for visually providing information to a user. The interface 210, processor 220 memory 230 and display 240 may be coupled together via conventional means to communicate information. The controller 200 may also include additional components typically included within a controller for a HVAC unit, such as a power supply or power port.

The controller 200 is configured to include a mechanical behavior evaluator. The mechanical behavior evaluator or a least a portion thereof, is implemented in the memory 220 and the processor 230 of the controller 200. For example, the sound examiner may be implemented as a series of operating instructions that are stored in the memory 220 and direct the operation of the processor 230 when initiated. The sound reservoir can also be stored in the memory 220 and interface with the processor 230 under the direction of the sound examiner.

FIG. 3 illustrates a chart of various operating phases of a sound examiner, such as the sound examiner of the mechanical behavior evaluator of FIG. 1. Illustrated are a first phase 310, a second phase 320 and a third phase 330. Each of the phases may be part of controller packages that increase in cost with an increase in the amount of included functionality. For example, a controller package including all three phases would typically cost more than a controller package with only the first phase 310. The events discussed with respect the FIG. 3 are mechanical events or events of mechanical components of an HVAC unit.

The first phase 310 is a characterizing phase that measures the sound associated with a mechanical event in a step 312 and uses the measured sound of the mechanical event as a means of diagnostics in a step 314. Step 312 includes determining how the measured sound sounds in a step 313. Step 313 may be used to verify that the mechanical event occurred. For example, was there even measured sound. Step 314 includes determining if the measured sound sounds correct in a step 315. For steps 313 and 315, the sound examiner can compare audio data generated from the measured sound to audio recordings.

The second phase 320 is an analyzing or diagnostic phase that includes analyzing the measured sound (i.e., audio data or signal) in a step 322 and determining if there is a change in the measure sound in a step 324. Step 322 includes determining the shape and duration (i.e., sound signature) of the measured sound in a step 323. Step 324 includes comparing the shape and duration of the measured sound to a corresponding sound signature in a step 325. The sound signature can be an audio recording in a sound reservoir.

The third phase 330 is a prognosticating phase that includes analyzing the measured sound from a maintenance perspective in a step 332 and determining what the change in the measure sound indicates from the maintenance perspective in a step 334. The analyzed measured sound can be compared to a maintenance schedule to determine wear of a component and the need for maintenance. Step 332 includes wirelessly communication the maintenance needs based on the analyzed sound in a step 323. Step 334 includes alerting various parties based on the change in the measured sound in a step 325. For example, the amount of change or the amount of difference in the measured sound compared to a sound signature may initiate various levels of alarms to various parties. The alarms may be wirelessly transmitted to the parties and indicate the potential issues. Multiple levels of alarms or alerts may be used to identify the potential issues or urgency. The second phase 320 and the third phase 330 both analyze and make determinations based on changes in the signal. However, different actions can be undertaken in the two phases based on the analyzing and determinations.

FIG. 4 illustrates a detailed flow diagram of an embodiment of a method 400 of carrying out audio monitoring of an HVAC unit. Portions of the method 400 correspond to phases of FIG. 3. The method 400 illustrates the operation of an audio monitoring system of an HVAC unit that includes a listening system and a mechanical behavior evaluator having a sound examiner and a sound reservoir. The left side of FIG. 4 lists the various events of the HVAC unit in response to a call for heat and when the demand for heat is reached. In FIG. 4, the left side reflects the normal operating procedures that occur with each component or device working properly. These events may be controlled by an HVAC controller.

The right side of FIG. 4 lists the corresponding actions of the audio monitoring system to the events. In one embodiment, the HVAC controller indicates the initiation of an event to the sound examiner for the sound examiner to sample audio data received during an expected time of the occurrence of the event. As such, the sound examiner may save a designated amount of time of audio data that corresponds to the event that has been indicated. The designated amount of time can be predetermined, can be updated or changed and can vary for different events or components.

The right side of FIG. 4 includes multiple listening and measuring steps. The listening portion of each step can be performed by a listening system, such as the listening system 140 of FIG. 1. Each listening step would include the generation of audio data. The measuring or comparing portion of each step can be performed by a sound examiner and may employ a sound reservoir. The method 400 begins in a step 405 with a call for heat. The call for heat may be received by an HVAC controller from a thermostat.

In a step 410, a relay for a combustion air inducer (CAI) of a furnace is closed and the CAI blower is turned-on in a step 415. A pressure switch closes indicating sufficient operation of the CAI in a step 420. Thereafter, an igniter heats up in a step 425 and a gas valve opens in a step 430. In as step 435, burners are lit. An indoor blower (ID) then turns-on in a step 440.

In a step 445, a determination is made that the demand for heat has been reached. As such, the gas valve is closed in a step 450 and the burners are exhausted in a step 455. The CAI and the ID blower are then turned off in steps 460 and 465, respectively.

Turning now to the right side of FIG. 4, listening to the CAI blower relay contactors is performed in a step 412. In a step 417, listening to the operation of the CAI blower is performed. In this step, listening for the CAI blower to ramp-up and use sound signatures to correlate RPMs may be performed. Listening for the pressure switch to close is performed in step 422 along with measuring the time it took for the pressure switch to close and reporting potential issues, such as, a bad switch or poor venting.

In a step 427, listening for the relay to ignite measuring the time for ignition are performed. Listening for the relay to open the gas valve and measuring the time to onset of combustion occur in a step 432. The sound signature for multiple or signal burners are examined with the appropriate audio data to determine flame stability in a step 437. In a step 442, the time from burner lit to blower startup is measured and the noise levels of the blower at different speeds are measured.

After the demand for heat has been reached in step 445, listening for the relay to close the gas valve and listening for the burners to be extinguished occur is steps 447 and 452, respectively. Thereafter, listening to and measuring the time from when the burner exhausts to the CAI stops occur in a step 457. In a step 462, listening to and measuring the time from when the burner exhausts to the ID blower stops are performed.

FIG. 5 illustrates a diagram representing an embodiment of audio measurement and analysis of an HVAC system when a call for heat occurs according to the principles of the disclosure. The vertical axis is in decibels and the horizontal axis is in time (seconds). Audio data representing measured sound is denoted as element 510. As illustrated, the audio data changes with respect to the occurrence of various events. A sound examiner can diagnose the audio data with respect to the events. Comparisons of the audio data 510 can be made by the sound examiner to audio recordings in a sound reservoir.

In response to a call for heat, a switch is closed to initiate demand for the first stage of heat at element 520. A contactor for the first stage of the CAI is then closed at element 530. At element 540, the contactor for the burner is closed. Thereafter, a switch is closed to engage the flame sensor at element 550. The contactor for the ID blower is this closed at element 560. Thereafter, the first stage of the ID blower occurs as denoted by element 570. At element 580, the contactor for the second stage of the CAI is closed. Thereafter, the second stage of the ID blower occurs as denoted by element 590.

FIG. 6 illustrates a diagram representing sound signatures as employed in an embodiment of a mechanical behavior evaluator constructed according to the principles of the disclosure. The sound signatures are for a burner relay and a CAI relay. The sound signature for the burner relay is denoted as 610 and the sound signature for the CAI relay is denoted as 620. The level and decay rate of measured sounds define their sound signature. FIG. 6 represents only two sound signatures. One skilled in the art will understand that multiple sound signatures of other events can be stored and/or analyzed in real time for both short and long term diagnostics. The sound signatures can be stored in a sound reservoir in an HVAC controller.

FIG. 7 is a flow diagram of an embodiment of a method 700 of audio monitoring of events of a HVAC unit carried out according to the principles of the disclosure. The method 700 may be carried out under the direction of a computer program product. In one embodiment, a controller of an HVAC unit is employed to carry out the method 700. The method 700 begins in a step 705.

In a step 710, audio data from a listening system of the HVAC unit is received, wherein the audio data corresponds to an event of the HVAC unit. In a step 720, the audio data is compared to an audio recording that corresponds to the event. The audio recording can be stored in a sound reservoir. In some embodiments, the audio data may be compared to multiple audio recordings. Occurrence of the event is verified in a step 730 based on the comparison.

In a step 740, the event is characterized based on the comparison. The audio data is analyzed in a step 750 based on the comparison to determine a condition of a component of the HVAC unit associated with the event. In a step 760, maintenance is prognosticated for the component based on the comparison. The type of maintenance needed and the urgency of the maintenance may be determined.

In a step 770, the audio data is stored in a sound reservoir and associated with the event. The audio data is also associated with existing audio recordings, such as sound signatures, that correspond to the event. The results of the verification, characterization, analysis and prognostication are communicated in a step 780. This can include the condition of a component of the HVAC unit. In one embodiment, the results are communicated wirelessly. The method 700 ends in a step 790.

The above-described methods may be embodied in or performed by various conventional digital data processors, microprocessors or computing devices, wherein these devices are programmed or store executable programs of sequences of software instructions to perform one or more of the steps of the methods, e.g., steps of the method of FIG. 3, 4 or 7. The software instructions of such programs may be encoded in machine-executable form on conventional digital data storage media that is non-transitory, e.g., magnetic or optical disks, random-access memory (RAM), magnetic hard disks, flash memories, and/or read-only memory (ROM), to enable various types of digital data processors or computing devices to perform one, multiple or all of the steps of one or more of the above-described methods, e.g., one or more of the steps of the method of FIG. 3, 4 or 7. Additionally, an apparatus, such as dedicated HVAC controller, may be designed to include the necessary circuitry to perform each step of the methods of FIG. 3, 4 or 7.

Those skilled in the art to which this application relates will appreciate that other and further additions, deletions, substitutions and modifications may be made to the described embodiments.

What is claimed is:

1. A controller for a heating, ventilating and air conditioning (HVAC) unit, comprising:
an interface configured to receive audio data from a listening system of said HVAC unit; and
a mechanical behavior evaluator coupled to said interface and configured to verify occurrence of an event of said HVAC unit based on said audio data.

2. The controller as recited in claim 1 wherein said mechanical behavior evaluator includes a sound reservoir configured to store audio recordings of various events of said HVAC unit.

3. The controller as recited in claim 2 wherein said mechanical behavior evaluator includes a sound examiner configured to perform said verify and configured to characterize said occurrence by comparing said audio data to at least one of said audio recordings.

4. The controller as recited in claim 3 wherein said sound examiner is further configured to analyze said audio data by comparing said audio data to at least one of said audio recordings.

5. The controller as recited in claim 3 wherein said sound examiner is further configured to prognosticate needed maintenance for a component of said HVAC system based on comparing said audio data to at least one of said audio recordings.

6. The controller as recited in claim 3 wherein said sound examiner is further configured to update said audio recordings with said audio data.

7. The controller as recited in claim 1 wherein said sound examiner is further configured to communicate a condition of a component of said HVAC unit based on comparing said audio data to at least one of said audio recordings.

8. A computer program product, comprising a non-transitory computer usable medium having a computer readable program code embodied therein, said computer readable program code adapted to be executed to implement a method of audio monitoring of events of a heating, ventilating and air conditioning (HVAC) unit, said method comprising:
receiving audio data from a listening system of said HVAC unit, said audio data associated with an event of said HVAC unit;
comparing said audio data to at least one audio recording that corresponds to said event; and
verifying occurrence of said event based on said comparing.

9. The computer program as recited in claim 8 wherein said audio recording is stored in a sound reservoir of a controller of said HVAC unit and includes a sound signature.

10. The computer program as recited in claim 8 wherein said method further includes characterizing said event based on said comparing.

11. The computer program as recited in claim 8 wherein said method further includes analyzing said audio data based on said comparing to determine a condition of a component of said HVAC unit associated with said occurrence.

12. The computer program as recited in claim 8 wherein said method further includes prognosticating maintenance for a component of said HVAC unit based on said comparing.

13. The computer program as recited in claim 8 wherein said method further includes storing said audio data in a sound reservoir of a controller of said HVAC unit and associating said stored audio data with said event.

14. The computer program as recited in claim 8 wherein said method further includes communicating a condition of a component of said HVAC unit based on said comparing.

15. A heating, ventilating and air conditioning (HVAC) unit, comprising:
a heating or cooling system configured to provide conditioned air, said heating or cooling system having a component;
a listening system configured to detect sound corresponding to an event associated with said component and generate audio data of said sound; and
a controller coupled to said operating system and said listening system, said controller comprising:
an interface configured to receive said audio data from said listening system of said HVAC unit; and
a mechanical behavior evaluator coupled to said interface and having:
a sound reservoir configured to store audio recordings of various events associated with said operating system; and
a sound examiner configured to verify occurrence of said event based on said audio data.

16. The HVAC unit as recited in claim 15 wherein said sound examiner is further configured to characterize said occurrence by comparing said audio data to at least one of said audio recordings.

17. The HVAC unit as recited in claim 15 wherein said sound examiner is further configured to analyze said audio data by comparing said audio data to at least one of said audio recordings.

18. The HVAC unit as recited in claim 15 wherein said sound examiner is further configured to prognosticate needed maintenance for said component based on comparing said audio data to at least one of said audio recordings.

19. The HVAC unit as recited in claim 15 wherein said sound examiner is further configured to update said audio recordings with said audio data.

20. The HVAC unit as recited in claim 15 wherein said sound examiner is further configured to communicate a condition of said component based on comparing said audio data to at least one of said audio recordings.
